(19) United States
(12) Patent Application Publication
(10) Pub. No.: US 2026/0110655 A1
(43) Pub. Date: Apr. 23, 2026

(54) GAS SENSOR

(71) Applicant: Niterra Co., Ltd., Nagoya-shi (JP)

(72) Inventors: Yusuke ANDO, Nagoya-shi (JP); Kensuke MIZUTANI, Nagoya-shi (JP)

(73) Assignee: Niterra Co., Ltd., Nagoya-shi (JP)

(21) Appl. No.: 19/361,860

(22) Filed: Oct. 17, 2025

(30) Foreign Application Priority Data
Oct. 18, 2024 (JP) 2024-182466
Aug. 5, 2025 (JP) 2025-130489

(51) Int. Cl. G01N 27/28; C22C 38/00; C22C 38/58; G01M 15/10

(52) U.S. Cl. CPC G01N 27/28; C22C 38/001; C22C 38/58; G01M 15/102

(57) ABSTRACT

A gas sensor includes a sensor element extending in the direction of an axial line and having electrode pads on the surface of a rear end side portion, metallic terminal members, which elastically contact the electrode pads, and a separator, which holds the metallic terminal members. The metallic terminal members are made of an Fe-based alloy and contain Ni in the range of 9.75 to 10.25 mass %, Cr in the range of 23.00 to 23.90 mass %, Mn in the range of 5.80 to 6.20 mass %, N in the range of 0.47 to 0.53 mass %, unavoidable impurities, and the balance of Fe. The gas sensor can be manufactured at low cost and is excellent in the reliability of electrical connection between the metallic terminal members and the sensor element at high temperature.

This application claims the benefit of Japanese Patent Application No. 2024-182466 filed on Oct. 18, 2024 and Japanese patent Application No. 2025-130489 filed on Aug. 5, 2025, which are incorporated by reference herein in their entireties.

### FIELD OF THE INVENTION

The present invention relates to a gas sensor having metallic terminal members electrically connected to a sensor element.

### BACKGROUND OF THE INVENTION

A known gas sensor for detecting the concentration of oxygen or NOx in exhaust gas of an automobile or the like includes a plate-shaped sensor element using solid electrolyte.

In a widely employed gas sensor of this type, electrode pads are provided on the surface of a rear end side portion of a plate-shaped sensor element, and metallic terminal members are brought into electrical contact with these electrode pads so as to take a sensor output signal from the sensor element out to an external circuit.

An Ni-based alloy (for example, Inconel (registered trademark) which is excellent in heat resistance and whose creep deformation is small even when it is exposed to high temperature (e.g., exhaust gas) is generally used as a material for the metallic terminal members (JP2013-181768A).

However, such an Ni-based alloy is expensive, which results in cost increase. Meanwhile, when an Fe-based alloy or the like whose Ni content is small is used for metallic terminal members, heat resistance becomes insufficient.

The present invention has been made in consideration of the above-described current situation, and an object of the present invention is to provide a gas sensor which can be manufactured at low cost and is excellent in the reliability of electrical connection between metallic terminal members and a sensor element at high temperature.

### SUMMARY OF THE INVENTION

A gas sensor of the present invention includes a sensor element extending in an axial direction of the gas sensor and having an electrode pad on a surface of a rear end side portion of the sensor element, a metallic terminal member which elastically contacts the electrode pad, and a separator which holds the metallic terminal member. The metallic terminal member contains Ni in the range of 9.75 to 10.25 mass %, Cr in the range of 23.00 to 23.90 mass %, Mn in the range of 5.80 to 6.20 mass %, N in the range of 0.47 to 0.53 mass %, unavoidable impurities, and the balance of Fe.

Although an alloy having the above-described composition can be an Fe-based alloy that is manufactured at lower cost as compared with Ni-based alloys, it exhibits high heat resistance. Accordingly, when the metallic terminal member has the above-described composition, it is possible to obtain a gas sensor which can be manufactured at low cost and is excellent in the reliability of electrical connection between the metallic terminal member and the sensor element at high temperature.

In the gas sensor of the present invention, the metallic terminal member may be configured such that the metallic terminal member has a main body portion which extends in the axial direction and is held by the separator in a state in which the main body portion is received by a terminal insertion hole of the separator, a contact portion which extends toward the electrode pad and comes into contact with the electrode pad, and a bent portion which connects the main body portion and the contact portion; at least the contact portion and the bent portion are constituted by a single plate having a plate surface; the bent portion has a protrusion extending along the plate surface; and, when viewed in a direction normal to the plate surface in a region where the protrusion is provided, the protrusion constitutes an outer edge of the bent portion.

When the sensor element is heated by a gas to be measured such as exhaust gas, the metallic terminal member in contact with the electrode pad of the sensor element also becomes hot.

In view of this, the protrusion is formed in such a manner that it constitutes the outer edge of the bent portion when viewed in a normal direction which is close to the axial direction. Thus, the outline of the bent portion becomes larger when viewed in the axial direction, and the projection area of the bent portion increases by an amount corresponding to the projection area of the protrusion.

Since the protrusion is present in the gap between the bent portion and the wall surface of the terminal insertion hole of the separator when viewed in the axial direction, it becomes easier to radiate heat of the metallic terminal member in the axial direction via the protrusion, thereby making it possible to prevent overheating of the metallic terminal member and further enhance the reliability of electrical connection between the metallic terminal member and the sensor element at high temperature.

Notably, in the sensor, a temperature gradient tends to be produced along the axial direction, and therefore, air in the sensor is likely to move in the axial direction. Therefore, heat in the vicinity of the metallic terminal member tends to easily dissipate in the axial direction in which the terminal insertion hole extends. Accordingly, in the case of a protrusion (a protrusion which protrudes upward in the axial direction) which does not constitute the outer edge of the bent portion and does not increase the projection area of the bent portion in the axial direction, although the surface area of the metallic terminal member increases because of presence of the protrusion itself, it is difficult for heat to pass through the protrusion in the axial direction, thereby making heat dissipation difficult.

In the gas sensor of the present invention, the separator may have an element insertion hole which receives a rear end portion of the sensor element, and the protrusion may extend toward the element insertion hole.

In this gas sensor, since the protrusion is disposed to close the element insertion hole (a portion thereof), radiant heat from the sensor element located on the forward end side of the metallic terminal member is prevented from being conducted to members on the rear end side of the metallic terminal member, whereby members which are disposed on the rear end side of the separator and are low in heat resistance (for example, a rubber grommet) can be protected from heat.

In the gas sensor of the present invention, the protrusion may be shifted with respect to the contact portion in a width direction of the metallic terminal member.

In this gas sensor, it is possible to prevent the reliability of electrical connection between the contact portion and the electrode pad from lowering, which would be caused by the protrusion contacting the contact portion.

In the gas sensor of the present invention, an initial spring force of the metallic terminal member in a state in which the metallic terminal member is incorporated into the gas sensor may be 3.0 N or more.

In this gas sensor, the metallic terminal member has high heat resistance despite that the metallic terminal member is formed of an Fe-based alloy which can be manufactured at low cost. Therefore, even when heat is applied to the metallic terminal member, lowering of contact pressure can be suppressed.

### Advantageous Effect of Invention

According to the invention, a gas sensor which can be manufactured at low cost and is excellent in the reliability of electrical connection between metallic terminal members and a sensor element at high temperature can be obtained.

### BRIEF DESCRIPTION OF THE DRAWINGS

These and other features and advantages of the present invention will become more readily appreciated when considered in connection with the following detailed description and appended drawings, wherein like designations denote like elements in the various views, and wherein:

FIG. 1 is a sectional view of a gas sensor according to an embodiment of the present invention;

FIG. 2 is a schematic plan view of a separator, as viewed from a forward end side, in a state in which metallic terminal members are held by the separator and a sensor element has been inserted into the separator;

FIG. 3 is a perspective view of a metallic terminal member;

FIG. 4 is a plan view of the metallic terminal member as viewed from the forward end side;

FIG. 5 is a perspective view showing a state in which a protrusion of the metallic terminal member according to the embodiment of the present invention constitutes the outer edge of a bent portion of the metallic terminal member; and

FIG. 6 is a perspective view showing a state in which a protrusion of a metallic terminal member does not constitute the outer edge of the bent portion of the metallic terminal member.

### DETAILED DESCRIPTION OF THE INVENTION

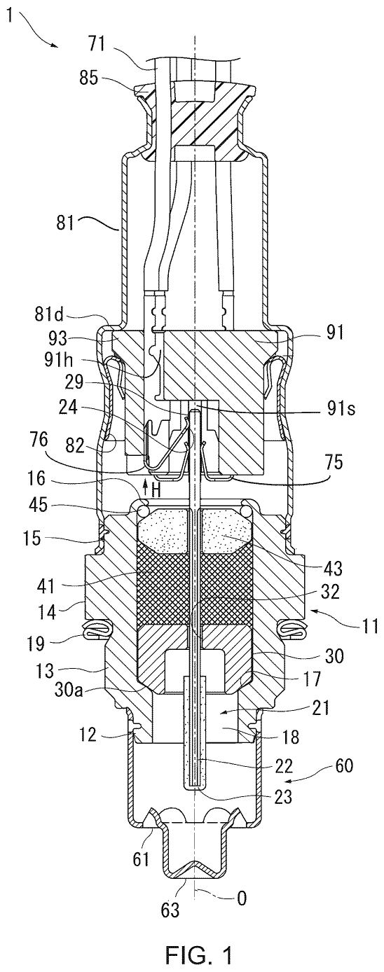

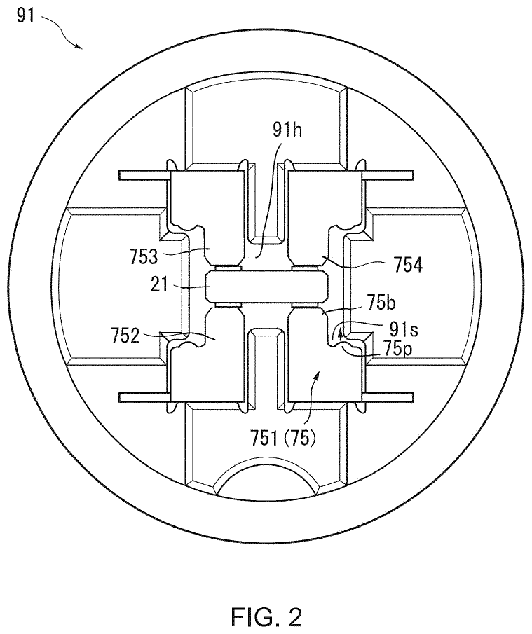

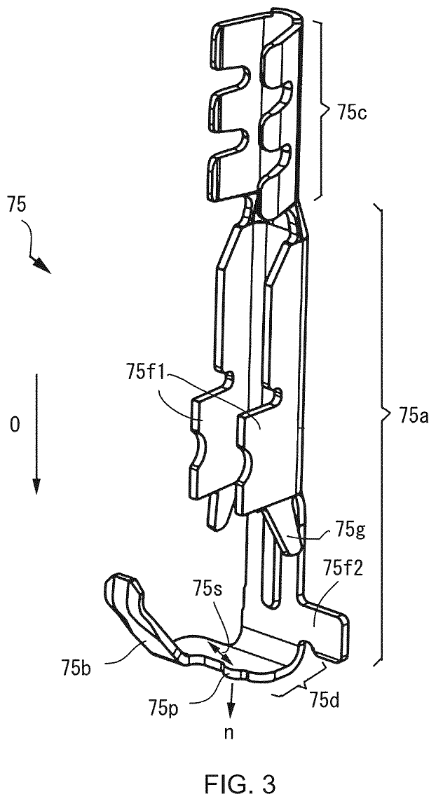

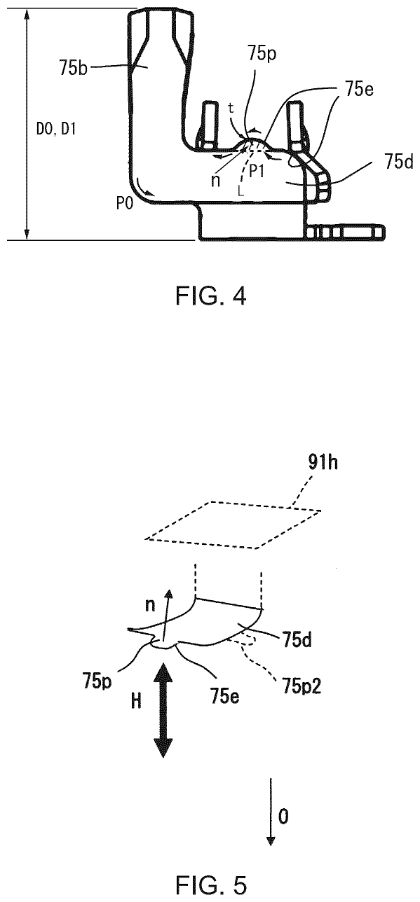

An embodiment of the present invention will be described in detail with reference to FIGS. 1 to 4. FIG. 1 is a sectional view of a gas sensor according to the embodiment of the present invention. FIG. 2 is a schematic plan view of a separator 91, as viewed from a forward end side, in a state in which metallic terminal members 75 are held by the separator 91 and a sensor element 21 has been inserted into the separator 91. FIG. 3 is a perspective view of a metallic terminal member 75. FIG. 4 is a plan view of the metallic terminal member 75 as viewed from the forward end side.

As shown in FIG. 1, the gas sensor (full-range air-fuel ratio gas sensor) 1 includes a sensor element 21; a holder (ceramic holder) 30 having a through hole 32 which extends in the direction of an axial line O and through which the sensor element 21 is passed; a metallic shell 11 which surrounds the circumference of the ceramic holder 30; metallic terminal members 75 and 76; and a separator 91 which holds the metallic terminal members 75 and 76.

A portion of the sensor element 21 located near a forward end and having a detection section 22 formed thereon protrudes forward from the ceramic holder 30. The sensor element 21 passed through the through hole 32 as described above is fixedly held inside the metallic shell 11. Specifically, a seal member (talc in this example) 41 disposed on the rear end surface side (the upper side in the drawing) of the ceramic holder 30 is compressed in a forward/rearward direction via a ring washer 45 and a sleeve 43 formed of an insulating material. As a result, the sensor element 21 is fixed inside the metallic shell 11 in a state in which gastightness in the forward/rearward direction is maintained.

Notably, a portion of the sensor element 21 which is located near its rear end 29 and includes the rear end 29 protrudes rearward from the sleeve 43 and the metallic shell 11, and electrode pads 24 are formed on the portion located near the rear end 29. The metallic terminal members 75 and 76, which are provided at forward ends of lead wires 71 extending to the outside through a rubber grommet 85, are pressed against the electrode pads 24, whereby the metallic terminal members 75 and 76 are electrically connected to the electrode pads 24. The portion of the sensor element 21 which is located near its rear end 29 and has the electrode pads 24 is covered with an outer tube 81. In the below, the sensor element 21 will be described in more details.

The sensor element 21 extends in the direction of the axial line O and has a strip shape (plate shape). The sensor element 21 has the detection section 22 in its forward end side portion (a lower side portion in the drawing) directed toward an object to be measured. The detection section 22 is composed of detection electrodes, etc. (not shown) and detects a particular gas component in a gas to be detected. The sensor element 21 is formed mainly of a ceramic material (solid electrolyte, etc.) to have an elongated shape and has a rectangular transverse cross section having a constant size over the entire length in the forward/rearward direction. This sensor element 21 itself has the same structure as those of conventionally known sensor elements. Specially, a pair of detection electrodes, which constitute the detection section 22, are disposed in a portion of the solid electrolyte (member) located near its forward end, and the electrode pads 24 electrically connected to the detection electrodes are formed on a portion of the solid electrolyte (member) located near its rear end such that the electrode pads 24 are exposed to the outside. Lead wires 71 for taking out the sensor output are connected to the electrode pads 24.

In the present example, the sensor element 21 includes a heater (not shown). A layer of a ceramic material (hereinafter referred to as the ceramic layer) is stacked on the solid electrolyte (member), and the heater is provided in a portion of the ceramic layer located near its forward end. Electrode pads 24 are formed on a portion of the ceramic layer located near its rear end such that the electrode pads 24 are exposed to the outside. Lead wires 71 for applying a volage to the heater are connected to the electrode pads 24.

Although not shown in the drawings, the electrode pads 24 are formed to have a rectangular shape (i.e., are elongated in the forward/rearward direction). For example, the electrode pads 24 are provided on a portion of the sensor element 21 located near the rear end 29 in such a manner that three or two electrode pads are laterally arranged on each of wider surfaces (opposite surfaces) of the strip-shaped sensor element 21.

Notably, the detection section 22 of the sensor element 21 is covered with a porous protection layer 23 formed of alumina, spinel, or the like.

The metallic shell 11 has a tubular shape and is composed of portions arranged in the forward/rearward direction, being coaxial with each other, and having different diameters. Specifically, the metallic shell 11 has a cylindrical ring-like portion (hereinafter also referred to as a cylindrical portion) 12 having a smaller-dimeter portion on the forward end side, and a protector 60, which will be described later, is fitted onto the cylindrical portion 12 and fixed thereto. A screw 13 used for fixing the gas sensor 1 to an exhaust pipe of an engine is provided on the outer circumferential surface of a portion located on the rear side (the upper side in the drawing) of the cylindrical portion 12. The screw 13 has a diameter larger than that of the cylindrical portion 12.

A polygonal portion 14 for screwing the gas sensor 1 into the exhaust pipe by using the screw 13 is provided on the rear side of the screw 13. A cylindrical portion 15 is provided on the rear side of the polygonal portion 14 to be located adjacent thereto. The protection tube (outer tube) 81 for covering a rear portion of the gas sensor 1 is fitted onto the cylindrical portion 15 and is welded thereto. A cylindrical portion for crimping 16, which is smaller in outer diameter and wall thickness than the cylindrical portion 15 is provided on the rear side of the cylindrical portion 15.

Notably, in FIG. 1, the cylindrical portion for crimping 16 has been bent inward because FIG. 1 shows a state after crimping. A gasket 19 for establishing a seal when the gas sensor 1 is screwed into the exhaust pipe is attached to a lower surface of the polygonal portion 14.

The metallic shell 11 has an internal hole 18 penetrating the metallic shell 11 in the direction of the axial line O. The inner circumferential surface of the internal hole 18 has a tapered step portion 17 where the diameter of the internal hole 18 decreases from the rear end side toward the forward end side.

The ceramic holder 30 formed of an insulating ceramic (for example, alumina) and generally having the shape of a short cylinder is disposed inside the metallic shell 11. The ceramic holder 30 has a forwardly facing surface 30a tapered such that the outer diameter of the ceramic holder 30 decreases toward the forward end.

A portion of the forwardly facing surface 30a located near its outer circumference is engaged with the step portion 17, and the ceramic holder 30 is pressed from the rear end side by the seal member 41, whereby the ceramic holder 30 is positioned within the metallic shell 11 and loosely fitted into the metallic shell 11.

The through hole 32 is provided at the center of the ceramic holder 30 and has a rectangular opening having dimensions approximately equal to those of the transverse cross section of the sensor element 21 so that the sensor element 21 extends through the through hole 32 with almost no clearance therebetween.

The sensor element 21 is passed through the through hole 32 of the ceramic holder 30, and the forward end of the sensor element 21 is caused to protrude forward from the forward end of the ceramic holder 30 and the forward end of the metallic shell 11.

A forward end portion of the sensor element 21 is covered with a protector (protection cover) 60 having gas passage holes 61 and 63. In the present embodiment, the protector 60 has a single-wall structure and has the shape of a bottomed cylinder. A rear end of the protector 60 is fitted onto the cylindrical portion 15 of the metallic shell 11 and is welded thereto. Notably, a plurality of gas passage holes 61 serving as introduction holes are provided in a step portion of the protector 60 located near the center in the direction of the axial line O. A single passage hole 63 serving as a discharge hole is provided on the forward end side of the protector 60.

As shown in FIG. 1, the metallic terminal members 75 and 76, which are provided at the forward ends of the lead wires 71 extending to the outside through the grommet 85, are pressed, by their spring properties, against the electrode pads 24, which are formed on the portion of the sensor element 21 located near the rear end 29, whereby the metallic terminal members 75 and 76 are electrically connected to the electrode pads 24.

In the gas sensor 1 of the present example, the metallic terminal members 75 and 76 having pressed portions are held in terminal insertion holes 91h provided in an insulating separator 91 disposed in the outer tube 81, in such a manner that the metallic terminal members 75 and 76 face each other.

An element insertion hole 91s, which receives the rear end 29 of the sensor element 21, is formed at the center of the separator 91, and the terminal insertion holes 91h are disposed to surround the element insertion hole 91s (FIG. 2).

On the forward end side of the separator 91, the element insertion hole 91s communicates with the terminal insertion holes 91h.

Notably, movement of the separator 91 in the radial direction and toward the forward end side is restrained by a metallic holder 82 fixed inside the outer tube 81 by means of crimping. A forward end portion of the outer tube 81 fitted onto and welded to the cylindrical portion 15 of the metallic shell 11, which portion is located near the rear end of the metallic shell 11, whereby a rear portion of the gas sensor 1 is gastightly covered.

The lead wires 71 are extended to the outside through a seal member (formed of, for example, rubber grommet 85) disposed inside a rear end portion of the outer tube 81. A second crimping portion having a small diameter is crimped to reduce the diameter, thereby compressing the grommet 85, whereby the gastightness of this portion is maintained.

Notably, the outer tube 81 has a large diameter portion on the forward end side and a small diameter portion on the rear end side, and has a step portion 81d located between the large diameter portion and the small diameter portion and extending radially inward. A rearwardly facing surface of the separator 91 is engaged with a forwardly facing surface of the step portion 81d. Meanwhile, the separator 91 is supported, via a flange 93 formed along the outer circumference of the separator 91, on the metallic holder 82 fixedly provided inside the outer tube 81, and the separator 91 is held in position in the direction of the axial line O by the step portion 81d and the metallic holder 82.

In addition, a rear end side portion of the outer tube 81 is crimped toward a radially inner side, whereby the grommet 85 is fixed inside the outer tube 81.

Next, the metallic terminal members 75 will be described.

Notably, although the gas sensor 1 of the present embodiment has four metallic terminal members 75 and one metallic terminal member 76 on the rear end side of the metallic terminal members 75, in the present embodiment, the metallic terminal member 76 is an output terminal and is excluded from the “metallic terminal member” recited in the claims. However, the metallic terminal member 76 may be the “metallic terminal member” of the present invention. The number of the metallic terminal member(s) 76 is not limited to one and may be zero or two or more.

As shown in FIG. 2, these four metallic terminal members 751 to 754 are line symmetry or point symmetry with each other. Therefore, the metallic terminal member 751 shown in FIG. 2 will be described as the “metallic terminal member 75” with reference to FIG. 3. However, the structures of other metallic terminal members 752 to 754 are also substantially the same as that of the metallic terminal member 751.

The metallic terminal member 75 is formed of an alloy containing Fe as a main component (hereinafter referred to as an “Fe-based alloy”). The Fe-based alloy contains 9.75 to 10.25 mass % Ni, 23.00 to 23.90 mass % Cr, 5.80 to 6.20 mass % Mn, 0.47 to 0.53 mass % N and unavoidable impurities, the balance being Fe.

Although the above-described Fe-based alloy can be manufactured at lower cost as compared with Ni-based alloys, the above-described Fe-based alloy exhibits high heat resistance. Accordingly, when the metallic terminal member 75 is formed of an Fe-based alloy having the above-described composition, it is possible to obtain a gas sensor which can be manufactured at low cost and is excellent in the reliability of electrical connection between the metallic terminal member 75 and the sensor element 21 at high temperature.

Notably, “containing Fe as a main component” means that the amount of Fe contained is more than 50 mass %.

As shown in FIG. 3, the metallic terminal member 75 has, as integrally formed portions, an approximately plate-shaped main body portion 75a extending in the direction of the axial line O, a contact portion 75b bent from a forward end of the main body portion 75a toward its rear end, a crimp terminal portion 75c connected to the rear end of the main body portion 75a, and a bent portion 75d connecting the main body portion 75a and the contact portion 75b.

The main body portion 75a is held by the separator 91 in a state in which the main body portion 75a is received by the terminal insertion hole 91h of the separator 91. The contact portion 75b extends toward the sensor element 21 (the electrode pad 24 of the sensor element 21) and comes into electrical contact with the electrode pad 24.

The bent portion 75d can deform elastically. As a result of elastic bending of the bent portion 75d, the contact portion 75b connected to the bent portion 75d is pressed against the electrode pad 24, whereby the contact portion 75b can come into contact with the electrode pad 24 without fail.

The crimp terminal portion 75c has a known tubular shape. The conductor of a lead wire 71, which is exposed by removing the coating of the lead wire 71, is inserted into the crimp terminal portion 75c, and the crimp terminal portion 75c is then crimped, whereby the lead wire 71 (see FIG. 1) is electrically connected to the metallic terminal member 75.

The metallic terminal member 75 can be manufactured by, for example, punching a single metal plate formed of the above-described Fe-based alloy, and bending the contact portion 75b and the bent portion 75d.

However, the method of manufacturing the metallic terminal member 75 is not limited thereto. However, at least the contact portion 75b and the bent portion 75d are constituted by a single plate having a plate surface.

As shown in FIG. 3, in the present example, the bent portion 75d has a protrusion 75p extending along the plate surface 75s.

As shown in FIG. 4, when viewed in a direction n normal to the plate surface 75s in a region (a hatched portion of FIG. 4) where the protrusion 75p is provided, the protrusion 75p constitutes an outer edge 75e of the bent portion.

The “plate surface 75s in the region (the hatched portion of FIG. 4) where the protrusion 75p is provided” is used as a refence for the normal direction n, because of the following reason. Namely, as shown in FIG. 3, since the bent portion 75d is formed by bending a plate, the bent portion 75d is not flat and is curved, and therefore, the direction of the normal line changes depending on the position on the bent portion 75d. In view of this, a normal line in the plate surface 75s in the “region where the protrusion 75p is provided” is employed.

The normal line is that at the centroid of the “region where the protrusion 75p is provided.”

The “region where the protrusion 75p is provided” will be described below.

The “region where the protrusion 75p is provided” is obtained as follows.

First, as shown in FIG. 4, the sign (positive or negative) of the radius of curvature of each of parts of the profile (outer edge 75e) of the bent portion 75d is obtained.

For example, at position P0 in FIG. 4, the outer edge 75e extends downward along a direction indicated by an arrow; i.e., the outer edge 75e extends from a part where the radius of curvature=0 (straight) and changes its direction to a horizontal direction by curving counterclockwise (the radius of curvature >0) at P0, thereby reaching a part where the radius of curvature=0 (straight). Namely, in the vicinity of position P0, the sign of the radius of curvature is one of two signs (positive and negative) (positive in this case).

Meanwhile, at position P1 in FIG. 4 (the protrusion 75p), along directions indicated by arrows, the outer edge 75e extending horizontally from the right side curves clockwise (the radius of curvature <0) while extending leftward; at the top of the protrusion 75p, the outer edge 75e curves counterclockwise (the radius of curvature >0) while extending leftward; and then, the outer edge 75e curves clockwise (the radius of curvature <0) while extending leftward. Namely, in a portion near position P1, between two positions at which the radius of curvature has one of two signs (positive and negative) (negative sign), a position at which the radius of curvature has the other of the two signs (positive and negative) (positive sign) is present. Such a portion is regarded as the “protrusion 75p.”

The “region where the protrusion 75p is provided” is a hatched region surrounded by a line L which connects the two positions at which the radius of curvature has one of two signs (positive and negative) and a position which constitutes the top t of the protrusion 75p and at which the radius of curvature has the other of the two signs (positive and negative).

Notably, between the two positions at which the radius of curvature has one of the two signs (positive and negative) (negative sign), two or more positions at which the radius of curvature has the other of the two signs (positive and negative) (positive sign) may be present.

Notably, in the present example, the main body portion 75a has a pair of retaining portions 75f1 provided approximately at its center portion in direction of the axial line O and a retaining portion 75f2 provided at its end on the forward end side in the direction of the axial line O of the main body portion 75a. The retaining portions 75f1 are provided at opposite edges of the center portion and are bent into an L-like shape, thereby extending toward the sensor element 21. The retaining portion 75f2 extends in a radial direction from the end on the forward end side.

These retaining portions 75f1 and 75f2 engage with predetermined portions of the wall surface of the terminal insertion hole 91h, thereby fixing the metallic terminal member 75 in the terminal insertion hole 91h.

Moreover, a pair of tongue-shaped engagement portions 75g are formed at the forward ends of the retaining portions 75f1 in such a manner that the engagement portions 75g expand radially outward, toward the forward end side. The pair of engagement portions 75g expand within the terminal insertion hole 91h and engage with the wall surface of the terminal insertion hole 91h, whereby the metallic terminal member 75 can be fixed inside the terminal insertion hole 91h without fail.

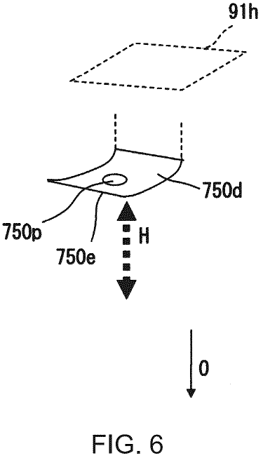

Next, the action of the protrusion 75p which constitutes the outer edge 75e of the bent portion 75d when viewed in the normal direction n will be described with reference to FIGS. 5 and 6.

As shown in FIGS. 1 and 5, the sensor element 21 is heated by a gas G to be measured such as exhaust gas, and the metallic terminal member 75 in contact with the corresponding electrode pad 24 of the sensor element 21 also becomes hot.

In view of this, as shown in FIG. 5, the protrusion 75p is formed in such a manner that it constitutes the outer edge 75e of the bent portion 75d when viewed in the normal direction n which is close to the direction of the axial line O. The outline of the bent portion 75d becomes larger when viewed in the direction of the axial line O, and the projection area of the bent portion 75d increases by an amount corresponding to the projection area of the protrusion 75p.

Since the protrusion 75p is present in the gap between the bent portion 75d and the wall surface of the terminal insertion hole 91h of the separator 91 when viewed in the direction of the axial line O, it becomes easier to radiate the heat H of the metallic terminal member 75 in the direction of the axial line O via the protrusion 75p, thereby making it possible to prevent overheating of the metallic terminal member 75 and further enhance the reliability of electrical connection between the metallic terminal member 75 and the sensor element 21 at high temperature.

Notably, the heat H of the metallic terminal member 75 tends to easily dissipate in the direction of the axial line O in which the terminal insertion hole 91h extends.

Here, the case where, as shown in FIG. 6, a protrusion 750p is provided on the bent portion 750d of the metallic terminal member in such a manner that the protrusion 750p protrudes from the plate surface of the bent portion 750d in the thickness direction is considered. Since this protrusion 750p does not constitute the outer edge 750e of the bent portion 750d, the outline of the bent portion 750d does not become larger when viewed in the direction of the axial line O, and the projection area of the bent portion 750d does not increase.

In this case, although the surface area of the metallic terminal member increases because of presence of the protrusion 750p itself, it is difficult for the heat H to pass through the protrusion in the direction of the axial line O, thereby making heat dissipation difficult. Therefore, the metallic terminal member 75 is overheated, and it becomes difficult to enhance the reliability of electrical connection between the metallic terminal member 75 and the sensor element 21 at high temperature.

In addition, since the protrusion 750p protrudes from the plate surface of the bent portion 750d in the thickness direction, the protrusion 750p functions as a rib, and it becomes difficult for the bent portion 750d to bend. As a result, the pressing force with which the contact portion connected to the bent portion 750d is pressed against the electrode pad may decrease.

In addition, as shown in FIG. 2, in the present example, the protrusion 75p extends toward the element insertion hole 91s (as indicated by an arrow in FIG. 2).

In this configuration, since the protrusion 75p is disposed to close the element insertion hole 91s (a portion thereof), radiant heat from the sensor element 21 located on the forward end side of the metallic terminal member 75 is prevented from being conducted to members on the rear end side of the metallic terminal member 75, whereby members which are disposed on the rear end side of the separator 91 and are low in heat resistance (for example, the rubber grommet 85) can be protected from heat.

As shown in FIGS. 3 and 4, in the present example, the protrusion 75p is disposed at a position which is shifted from the position of the contact portion 75b in the width direction of the metallic terminal member 75.

By virtue of this, it is possible to prevent lowering of the reliability of electrical connection between the contact portion 75b and the electrode pad 24, which lowering would otherwise occur due to contact between the protrusion 75p and the contact portion 75b.

The gas sensor of the present invention can be embodied by appropriately changing its structure and configuration without departing from the gist of the present invention.

The sensor element is not limited to those for measuring the concentration of oxygen, and may be a sensor element for measuring, for example, the concentration of nitrogen oxide (NOx) or hydrocarbon (HC).

No limitation is imposed on the shape, position, and number of the protrusions provided on the bent portion 75d. For example, as shown in FIG. 5, in addition to (or in place of) the protrusion 75p facing the sensor element 21, a second protrusion 75p2 facing in the radial direction may be provided.

The shape of the metallic terminal member is not limited to the shape shown in FIG. 3. For example, the metallic terminal member may have a shape in which the contact portion 75b is directly connected to the main body portion 75a without interposing the bent portion 75d.

### EXAMPLES

Metallic terminal members (each having the shape shown in FIG. 3) of Examples 1 to 3 and Comparative Example 1 were produced in such a manner that the metallic terminal members had different spring forces by changing the dimensions of the contact portion 75b and the bent portion 75d of each metallic terminal member, and the metallic terminal members were incorporated into gas sensors having the same structure as the gas sensor shown in FIG. 1.

In the case of Examples 1 to 3, the metallic terminal members were formed of an Fe-based alloy which contained 9.75 to 10.25 mass % Ni, 23.00 to 23.90 mass % Cr, 5.80 to 6.20 mass % Mn, 0.47 to 0.53 mass % N, and unavoidable impurities, the balance being Fe. In the case of Comparative Example 1, the metallic terminal members were formed of an Fe-based alloy which contained 4.00 to 4.60 mass % Ni, 16.50 to 17.35 mass % Cr, 14.00 to 15.00 mass % Mn, 0.30 to 0.35 mass % N, and unavoidable impurities, the balance being Fe.

The deformation amount DO of the metallic terminal member 75 in a state in which it was incorporated into a new (unheated) gas sensor 1 was measured.

Subsequently, the metallic terminal member 75 was removed from the gas sensor 1, and the deformation amount D1 of the metallic terminal member 75 was measured.

As shown in FIG. 4, each of the deformation amounts DO and D1 is the maximum distance (spring height) from the back surface of the main body portion 75a of the metallic terminal member 75 to the contact portion 75b.

Furthermore, the load applied to the removed metallic terminal member 75 for causing a displacement of (D1-D0) was measured by using a load meter, and the load at that time was used as an “initial spring force of the metallic terminal member.”

Subsequently, after heating this metallic terminal member 75 at 540° C. in an air atmosphere for 75 hours and cooling it to room temperature, the load applied to the removed metallic terminal member 75 for causing the displacement of (D1-D0) was similarly measured. The load at that time was used as a “spring force after durability test.”

Subsequently, the metallic terminal member 75 having undergone the durability test was incorporated into the sensor and the state of contact with the sensor element (the electrode pad 24) was judged. The criteria for judgment were determined as follows.
AA: Spring force after durability test is 4.5 N or more
A: Spring force after durability test is 2.5 N or more and less than 4.5 N
X: Spring force after durability test is less than 2.5 N

The obtained results are shown in Table 1.

TABLE 1

| | | | State of contact |
|---|---|---|---|
| | Initial spring | Spring force after | with element |
| | force (N) | durability test (N) | (electrode pad) |
| Example 1 | 3.0 | 2.8 | A |
| Example 2 | 7.3 | 4.7 | AA |
| Example 3 | 8.4 | 5.1 | AA |
| Comparative | 2.7 | 1.7 | X |
| Example 1 | | | |

In the case of Examples 1 to 3 in which the initial spring force of the metallic terminal member was 3.0 (N) or more, lowering of the spring force after the durability test was small, and the state of contact with the sensor element (the electrode pad 24) was good.

In the case of Comparative Example 1 in which the initial spring force of the metallic terminal member was less than 3.0 (N), lowering of the spring force after the durability test was remarkable, and the state of contact with the sensor element (the electrode pad 24) deteriorated.

What is claimed is:

1. A gas sensor comprising:
a sensor element extending in an axial direction of the gas sensor and having an electrode pad on a surface of a rear end side portion of the sensor element;
a metallic terminal member, which elastically contacts the electrode pad; and
a separator, which holds the metallic terminal member, wherein
the metallic terminal member contains Ni in a range of 9.75 to 10.25 mass %, Cr in a range of 23.00 to 23.90 mass %, Mn in a range of 5.80 to 6.20 mass %, N in a range of 0.47 to 0.53 mass %, unavoidable impurities, and a balance of Fe.

2. The gas sensor according to claim 1, wherein
the metallic terminal member has a main body portion, which extends in the axial direction and is held by the separator in a state in which the main body portion is received by a terminal insertion hole of the separator, a contact portion, which extends toward the electrode pad and contacts the electrode pad, and a bent portion which connects the main body portion and the contact portion,
at least the contact portion and the bent portion are constituted by a single plate having a plate surface,
the bent portion has a protrusion extending along the plate surface, and
when viewed in a direction normal to the plate surface in a region where the protrusion is provided, the protrusion constitutes an outer edge of the bent portion.

3. The gas sensor according to claim 2, wherein
the separator has an element insertion hole which receives a rear end portion of the sensor element, and
the protrusion extends toward the element insertion hole.

4. The gas sensor according to claim 2, wherein the protrusion is shifted with respect to the contact portion in a width direction of the metallic terminal member.

5. The gas sensor according to claim 1, wherein an initial spring force of the metallic terminal member in a state in which the metallic terminal member is incorporated into the gas sensor is 3.0 N or more.
